(19) United States
(12) Patent Application Publication
(10) Pub. No.: US 2025/0116832 A1
(43) Pub. Date: Apr. 10, 2025

(54) OPTICAL FIBER CABLE

(71) Applicant: SUMITOMO ELECTRIC INDUSTRIES, LTD., Osaka (JP)

(72) Inventors: Toru KUROSAWA, Osaka (JP); Toyoaki KIMURA, Osaka (JP); Yohei SUZUKI, Osaka (JP); Takemasa AKIYAMA, Osaka (JP); Fumikazu YOSHIZAWA, Osaka (JP); Takao HIRAMA, Osaka (JP); Yuji NORISUGI, Osaka (JP); Ryo TOGASHI, Osaka (JP); Fumiaki SATO, Osaka (JP)

(21) Appl. No.: 18/906,269

(22) Filed: Oct. 4, 2024

(30) Foreign Application Priority Data
Oct. 6, 2023 (JP) 2023-174373

(51) Int. Cl. G02B 6/44

(52) U.S. Cl. CPC G02B 6/443

(57) ABSTRACT

An optical fiber cable includes a cable core including a plurality of optical fibers, a tensile strength member disposed along the cable core, and a sheath covering the cable core and enclosing the tensile strength member. The tensile strength member includes an exposed portion exposed from the sheath to an inside of the cable core. In a cross-sectional view of the optical fiber cable, the exposed portion includes a portion in which a line segment intersects an outer periphery of the tensile strength member, the line segment connecting a center of the tensile strength member and a center of the optical fiber cable.

### CROSS-REFERENCE TO RELATED APPLICATIONS

This application is based on and claims priority under 35 USC 119 from Japanese Patent Application No. 2023-174373 filed on Oct. 6, 2023, the entire content of which is incorporated herein by reference.

### TECHNICAL FIELD

The present disclosure relates to an optical fiber cable.

### BACKGROUND ART

The related art discloses an optical fiber cable including a cable core including a plurality of optical fibers, a tensile strength member, and a sheath covering the cable core. For example, in an optical fiber cable disclosed in JP2023-73421A, a tension member which is a tensile strength member is enclosed in a sheath.

A pressure may be applied to the optical fiber cable from an outside along a direction connecting the tensile strength member enclosed in the sheath and a vicinity of a center of the optical fiber cable. In such a case, the tensile strength member presses the sheath between the tensile strength member and the cable core, and damage such as cracks may occur when the sheath is thin.

### SUMMARY OF INVENTION

Aspect of non-limiting embodiments of the present disclosure relates to provide an optical fiber cable capable of preventing damage to a sheath when a pressure is applied to the optical fiber cable from an outside.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an optical fiber cable including:
a cable core including a plurality of optical fibers;
a tensile strength member disposed along the cable core; and
a sheath covering the cable core and enclosing the tensile strength member,
in which the tensile strength member includes an exposed portion exposed from the sheath to an inside of the cable core, and
in a cross-sectional view of the optical fiber cable, the exposed portion includes a portion in which a line segment intersects an outer periphery of the tensile strength member, the line segment connecting a center of the tensile strength member and a center of the optical fiber cable.

### BRIEF DESCRIPTION OF DRAWINGS

Exemplary embodiment(s) of the present invention will be described in detail based on the following figures, wherein:

FIG. 1 is a cross-sectional view perpendicular to a longitudinal direction of an optical fiber cable according to an embodiment of the present disclosure;

FIG. 2 is a cross-sectional view perpendicular to a longitudinal direction of an optical fiber cable according to a comparative example;

FIG. 3 is a view illustrating a to-be-solved problem of the optical fiber cable according to the comparative example shown in FIG. 2;

FIG. 4 is a cross-sectional view illustrating a state in which a pressure from an outside is applied to the optical fiber cable according to the embodiment of the present disclosure; and

FIG. 5 is a cross-sectional view perpendicular to a longitudinal direction of an optical fiber cable according to a modification of the embodiment of the present disclosure.

### DESCRIPTION OF EMBODIMENTS

### Description of Embodiments of Present Disclosure

First, an embodiment of the present disclosure will be listed and described.

An optical fiber cable according to an embodiment of the present disclosure is (1) an optical fiber cable including:
a cable core including a plurality of optical fibers;
a tensile strength member disposed along the cable core; and
a sheath covering the cable core and enclosing the tensile strength member, in which
the tensile strength member includes an exposed portion exposed from the sheath to an inside of the cable core, and
in a cross-sectional view of the optical fiber cable, the exposed portion includes a portion in which a line segment intersects an outer periphery of the tensile strength member, the line segment connecting a center of the tensile strength member and a center of the optical fiber cable.

With such a configuration, even when a pressure from an outside is applied to the optical fiber cable along a direction connecting the center of the tensile strength member and a vicinity of the center of the optical fiber cable, damage to the sheath can be prevented because there is no sheath between the cable core and the tensile strength member and the tensile strength member can be prevented from pressing the sheath between the cable core and the tensile strength member.

(2) The optical fiber cable according to (1), in which
in the cross-sectional view of the optical fiber cable, a width of the exposed portion may be in a range of 1.5% to 6% of an outer periphery of the cable core.

With such a configuration, the tensile strength member can be prevented from pressing the sheath between the cable core and the tensile strength member, and the tensile strength member can be prevented from completely falling off from the sheath.

(3) The optical fiber cable according to (1) or (2), in which
in the cross-sectional view of the optical fiber cable, the tensile strength member may be provided at one position.

Here, when the tensile strength member are provided at two positions in the cross-sectional view of the optical fiber cable, bending rigidity changes depending on a bending direction of the optical fiber cable. That is, in such an optical fiber cable, there are an easy bending direction and a hard bending direction. Meanwhile, when the tensile strength member is provided at one position in the cross-sectional view of the optical fiber cable as described above, the bending direction is not limited as compared with when the tensile strength member is provided at two positions.

In addition, when the tensile strength member is provided at one position, it is desirable that the tensile strength member having a large outer diameter is disposed closer to the cable core, from the viewpoint of making it difficult to cause directional bending and ensuring tensile strength of the optical fiber cable. In the optical fiber cable according to the present disclosure, since the tensile strength member is exposed to the inside of the cable core, the sheath can be prevented from being damaged even when the tensile strength member having a large outer diameter is disposed closer to the cable core. That is, according to the configuration described above, it is possible to prevent directional bending and ensure the tensile strength of the optical fiber cable while preventing damage to the sheath.

(4) The optical fiber cable according to (3), in which
a center of the cable core may be located on an opposite side of the tensile strength member with respect to the center of the optical fiber cable.

With such a configuration, since a thickness between the tensile strength member and an outer periphery of the sheath can be increased, a load on the tensile strength member when a pressure from the outside is applied can be reduced.

(5) The optical fiber cable according to any one of (1) to (4), in which
the tensile strength member may be made of fiber-reinforced plastic.

With such a configuration, it is possible to provide an optical fiber cable structure using a tensile strength member that has a relatively high rigidity and is less likely to buckle.

### Details of Embodiments of Present Disclosure

A specific example of an optical fiber cable according to the present disclosure will be described below with reference to the drawings. The present disclosure is not limited to these exemplifications, but is indicated by the scope of claims, and is intended to include all modifications within a scope and meaning equivalent to the scope of claims.

### Configuration of Optical Fiber Cable

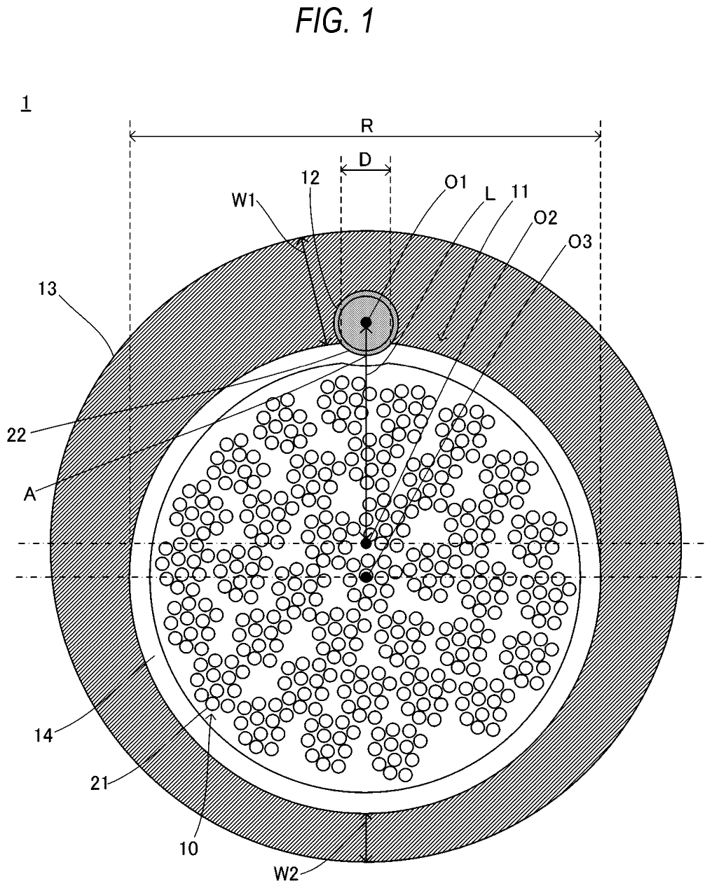

FIG. 1 is a cross-sectional view perpendicular to a longitudinal direction of an optical fiber cable 1 according to an embodiment of the present disclosure. The optical fiber cable 1 is, for example, a slotless optical fiber cable for air pumping. As shown in FIG. 1, the optical fiber cable 1 includes a cable core 11, a tensile strength member 12, and a sheath 13. The optical fiber cable 1 has a substantially circular shape in the cross-sectional view, and an outer diameter thereof is in a range of 9.0 mm to 10.0 mm, for example.

The cable core 11 has a substantially circular shape in the cross-sectional view, and an outer diameter thereof is in a range of 5.5 mm to 6.5 mm, for example. The cable core 11 includes a plurality of optical fiber ribbons 10, and a wrapping tape 14 covering the plurality of optical fiber ribbons 10. The cable core 11 shown in FIG. 1 includes, for example, 24 optical fiber ribbons 10. Each of the optical fiber ribbons 10 includes, for example, 12 optical fibers 21.

In each optical fiber ribbon 10, the plurality of optical fibers 21 are arranged in parallel in a direction orthogonal to a longitudinal direction of the optical fiber ribbon 10. For example, among the plurality of optical fibers 21, a connecting portion in a state in which the adjacent optical fibers 21 are connected, and a non-connecting portion in a state in which the adjacent optical fibers 21 are not connected, are intermittently provided in the longitudinal direction. Each of the optical fiber ribbons 10 is accommodated in a rounded state in a cross-sectional view.

The sheath 13 covers the cable core 11 from the outside and encloses the tensile strength member 12. The tensile strength member 12 is disposed along the cable core 11. The tensile strength member 12 has a circular shape in the cross-sectional view, and has an outer diameter of about 1.8 mm, for example. The term “enclose” includes not only a state in which the entire tensile strength member 12 is enclosed in the sheath 13 but also a state in which a part of the tensile strength member 12 is enclosed.

The tensile strength member 12 is made of, for example, fiber-reinforced plastic (FRP). Specifically, the tensile strength member 12 is made of a fiber-reinforced plastic such as aramid FRP, glass FRP, or carbon FRP. Accordingly, it is possible to provide an optical fiber cable structure using the tensile strength member 12 that has a relatively high rigidity and is less likely to buckle.

Further, the tensile strength member 12 includes an exposed portion 22 exposed from the sheath 13 to an inside of the cable core 11. In the cross-sectional view of the optical fiber cable 1, the exposed portion 22 includes an intersection portion A in which a line segment L connecting a center O1 of the tensile strength member 12 and a center O2 of the optical fiber cable 1 intersects an outer periphery of the tensile strength member 12. Further, the tensile strength member 12 is disposed such that the exposed portion 22 including the intersection portion A is located closer to a center O3 of the cable core 11 than is the outer periphery of the cable core 11 is. Accordingly, a part of the wrapping tape 14 on the cable core 11 protrudes toward the center O3 of the cable core 11.

The tensile strength member 12 is not limited to the configuration in which the tensile strength member 12 is exposed to the inside of the cable core 11 over an entire length in a longitudinal direction of the cable core 11, and may be configured such that the exposed portion 22 is intermittently provided along the longitudinal direction of the cable core 11. That is, the exposed portion 22 as shown in FIG. 1 may be provided on a part of the cable core 11 in the longitudinal direction, and the entire tensile strength member 12 may be enclosed in the sheath 13 on the other part in the longitudinal direction.

Influence on Sheath when Pressure from Outside is Applied to Optical Fiber Cable According to Comparative Example

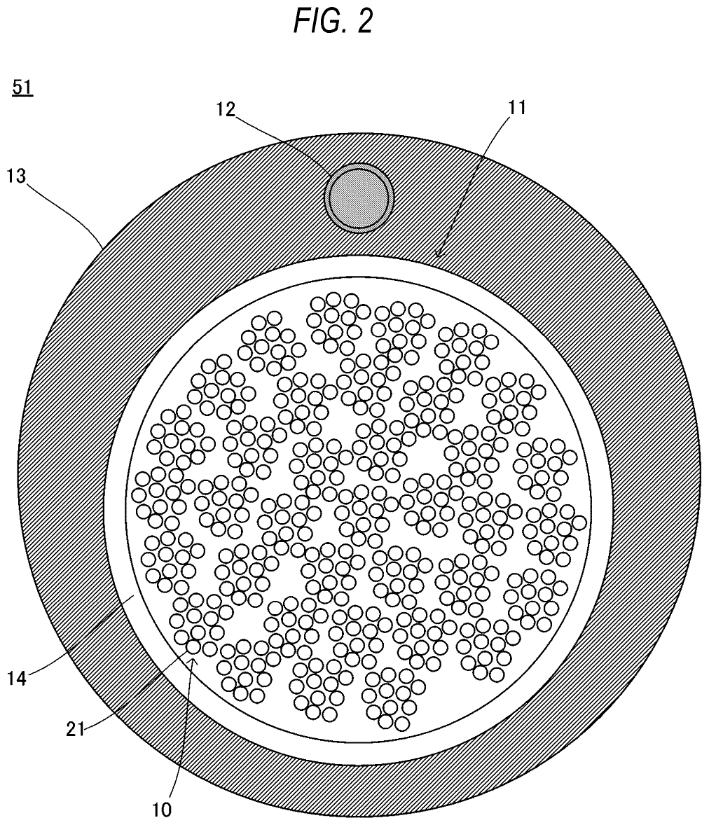

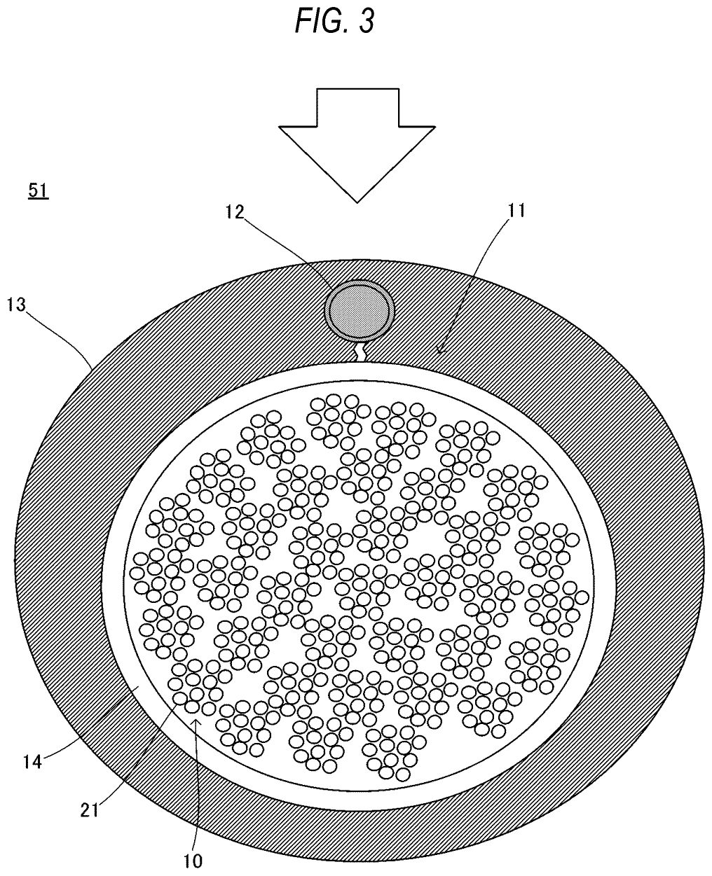

FIG. 2 is a cross-sectional view perpendicular to a longitudinal direction of an optical fiber cable 51 according to a comparative example. FIG. 3 is a view illustrating a to-be-solved problem of the optical fiber cable 51 according to the comparative example shown in FIG. 2. As shown in FIG. 2, in the optical fiber cable 51 according to the comparative example, the entire tensile strength member 12 is enclosed in the sheath 13.

In such an optical fiber cable 51, as indicated by an arrow in FIG. 3, when a pressure from the outside is applied along a direction connecting the tensile strength member 12 and a vicinity of a center of the optical fiber cable 51, the tensile strength member 12 presses the sheath 13 between the cable core 11 and the tensile strength member 12. Therefore, when the portion of the sheath 13 pressed by the tensile strength member 12 is thin, damage such as cracks may occur in the portion.

### Optical Fiber Cable According to Present Disclosure

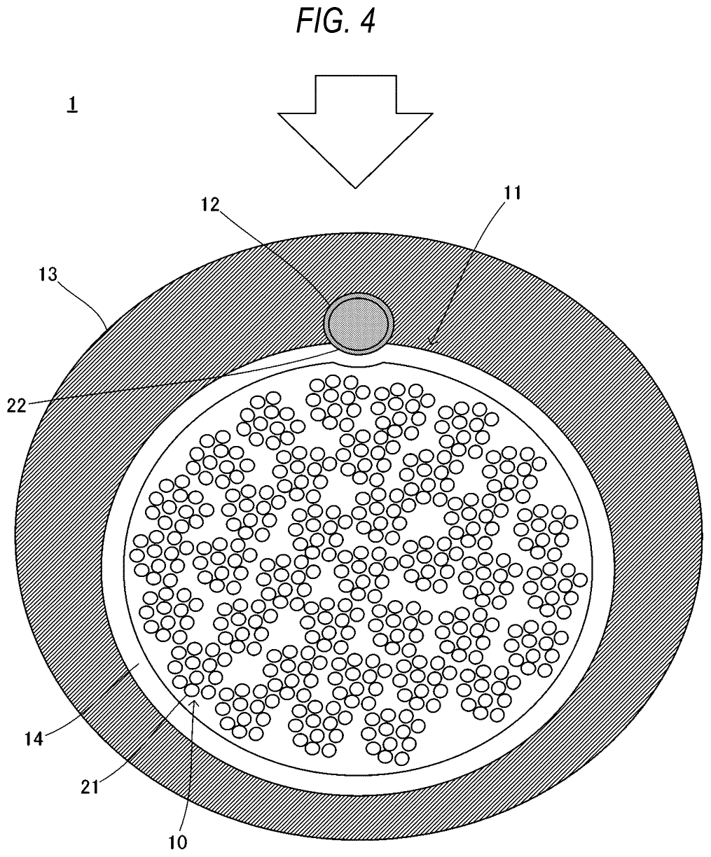

FIG. 4 is a cross-sectional view illustrating a state in which a pressure from the outside is applied to the optical fiber cable 1 according to the embodiment of the present disclosure. In the optical fiber cable 1 according to the present disclosure, as described above, the exposed portion 22 of the tensile strength member 12 is exposed from the sheath 13 to the inside of the cable core 11. That is, there is no sheath 13 between the tensile strength member 12 and the cable core 11. Therefore, as indicated by an arrow in FIG. 4, even when a pressure from the outside is applied toward the center of the optical fiber cable 1, cracks or the like of the sheath 13 can be prevented.

Referring again to FIG. 1, for example, when the outer diameter of the tensile strength member 12 is 1.8 mm and the outer diameter of the cable core 11 is 6.5 mm, in the cross-sectional view of the optical fiber cable 1, a width D of the exposed portion 22 is preferably in a range of 1.5% to 6% of the outer periphery of the cable core 11. Specifically, the width D of the exposed portion 22 is formed in a range of 0.5 mm to 1.05 mm, that is, in a range of about 2% to about 5% of the outer periphery (=6.5 mm×π) of the cable core 11. Accordingly, the tensile strength member 12 can be prevented from pressing the sheath 13 between the cable core 11 and the tensile strength member 12, and the tensile strength member 12 can be prevented from completely falling off from the sheath 13. The outer diameter of the tensile strength member 12 is larger than the width D of the exposed portion 22.

In the cross-sectional view of the optical fiber cable 1, the tensile strength member 12 may be provided at one position. Here, when the tensile strength member 12 are provided at two positions with the cable core 11 interposed therebetween in the cross-sectional view of the optical fiber cable, for example, bending rigidity changes depending on a bending direction of the optical fiber cable. That is, in such an optical fiber cable, there are an easy bending direction and a hard bending direction. Meanwhile, when the tensile strength member 12 is provided at one position in the cross-sectional view of the optical fiber cable 1 as shown in FIG. 1, the bending direction is not limited as compared with when the tensile strength member 12 is provided at two positions.

In addition, when the tensile strength member 12 is provided at one position, directional bending is less likely to occur when the tensile strength member 12 is disposed on an inner side of the optical fiber cable 1, that is, closer to the center O3 of the cable core 11. In addition, in order to ensure tensile strength of the optical fiber cable 1, it is necessary to increase the outer diameter of the tensile strength member 12 as compared with when the tensile strength member 12 is provided at a plurality of positions. That is, when the tensile strength member 12 is provided at one position, the tensile strength member 12 having a large outer diameter is preferably disposed closer to the center O3 of the cable core 11.

On the other hand, when the tensile strength member 12 is too close to the cable core 11, as described in the comparative example, the sheath 13 between the tensile strength member 12 and the cable core 11 is thinned, and damage such as cracks is likely to occur in the sheath 13. Meanwhile, in the optical fiber cable 1 according to the present disclosure, since the tensile strength member 12 is exposed to the inside of the cable core 11, the tensile strength member 12 having a large outer diameter can be disposed closer to the center O3 of the cable core 11, and it is possible to prevent the directional bending from occurring while preventing damage of the sheath 13.

In addition, in the optical fiber cable 1 shown in FIG. 1, the center O3 of the cable core 11 is located on an opposite side of the tensile strength member 12 with respect to the center O2 of the entire optical fiber cable 1. That is, the cable core 11 and the tensile strength member 12 are disposed such that a thickness W1 of the sheath 13 on a tensile strength member 12 side is larger than a thickness W2 of the sheath 13 on the opposite side of the tensile strength member 12. For example, the thickness W1 of the sheath 13 on the tensile strength member 12 side is 2.9 mm, and the thickness W2 of the sheath 13 on the opposite side of the tensile strength member 12 is 2.0 mm. In this way, by increasing the thickness W1 between the tensile strength member 12 and the outer periphery of the sheath 13, a load on the tensile strength member 12 when a pressure from the outside is applied can be reduced.

### Modification

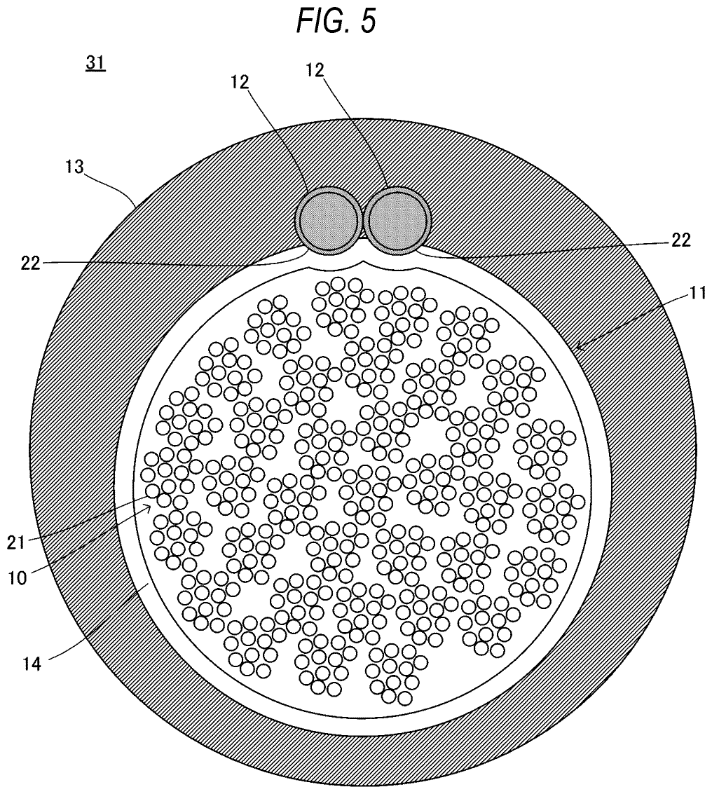

FIG. 5 is a cross-sectional view perpendicular to a longitudinal direction of an optical fiber cable 31 according to a modification of the embodiment of the present disclosure. As shown in FIG. 5, the number of the tensile strength member 12 in the cross-sectional view of the optical fiber cable 31 is not limited to one, and may be plural. In the example shown in FIG. 5, in the cross-sectional view of the optical fiber cable 31, a set including two tensile strength members 12 is provided at one position.

As described above, when a plurality of tensile strength members 12 are provided in the cross-sectional view, each tensile strength member 12 also includes the exposed portion 22 exposed from the sheath 13 to the inside of the cable core 11, similarly to the optical fiber cable 1 shown in FIG. 1. In this case, each exposed portion 22 also includes an intersection portion in which a line segment connecting the center of the tensile strength member 12 and a center of the optical fiber cable 31 intersects the outer periphery of the tensile strength member 12. Accordingly, even when a pressure from the outside is applied toward the center of the optical fiber cable 31, cracks or the like of the sheath 13 can be prevented.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An optical fiber cable comprising:
a cable core including a plurality of optical fibers;
a tensile strength member disposed along the cable core; and
a sheath covering the cable core and enclosing the tensile strength member,
wherein the tensile strength member includes an exposed portion exposed from the sheath to an inside of the cable core, and
in a cross-sectional view of the optical fiber cable, the exposed portion includes a portion in which a line segment intersects an outer periphery of the tensile strength member, the line segment connecting a center of the tensile strength member and a center of the optical fiber cable.

2. The optical fiber cable according to claim 1,
wherein in the cross-sectional view of the optical fiber cable, a width of the exposed portion is in a range of 1.5% to 6% of an outer periphery of the cable core.

3. The optical fiber cable according to claim 1,
wherein in the cross-sectional view of the optical fiber cable, the tensile strength member is provided at one position.

4. The optical fiber cable according to claim 3,
wherein a center of the cable core is located on an opposite side of the tensile strength member with respect to the center of the optical fiber cable.

5. The optical fiber cable according to claim 1,
wherein the tensile strength member is made of fiber-reinforced plastic.
